(19) United States
(12) Patent Application Publication
(10) Pub. No.: US 2023/0143431 A1
(43) Pub. Date: May 11, 2023

(54) BLADE COVER AND AXE ASSEMBLY

(71) Applicant: Fiskars Finland Oy Ab, Espoo (FI)

(72) Inventor: Mikko Kemppi, Espoo (FI)

(21) Appl. No.: 17/974,979

(22) Filed: Oct. 27, 2022

(30) Foreign Application Priority Data
Nov. 5, 2021 (EP) 21206680.7

(51) Int. Cl. B26B 29/00; B26B 23/00

(52) U.S. Cl. CPC B26B 29/00; B26B 23/00

(57) ABSTRACT

A blade cover for an axe includes a protective portion arranged to cover a sharp edge of a tool head. The blade cover has a locking mechanism releasably attachable to the tool head, the locking mechanism includes a rotatable switch and a receiver, the rotatable switch is rotatable between two positions, so that in a first position the blade cover is fixedly securable to the tool head, and in a second position the blade cover is releasably attachable to the tool head. An axe assembly is also provided and includes an axe having a tool head and a handle, where the tool head includes a through hole, and the blade cover.

### CROSS-REFERENCE TO RELATED PATENT APPLICATIONS

This application claims the benefit of priority to European patent application number 21206680.7, filed on Nov. 5, 2021, the complete disclosure of which is hereby incorporated by reference in its entirety.

### FIELD

The present invention relates to a blade cover and an axe assembly, and more particularly to a blade cover with a locking mechanism.

### BACKGROUND

The axe has many forms and specialized uses. The axe can be for example a splitting axe or a hatchet, also known as a camping axe. The most common form of the axe typically has a long handle with a steel head. The steel head may have a sharp edge and a poll. The splitting axe can be used with two hands, whereas the hatchet is a one-handed striking tool with a sharp edge on one side used for cutting and splitting wood, and a hammer head on the other side for striking purposes. Hatchets are lighter and has smaller size compared to usual axes making them easy to storage and travel.

Conventional blade covers usually cover both the sharp edge and the hammer head. Therefore, when using the hammer head of the axe, the user needs to take off the blade cover. This exposes the sharp edge of the axe and causes a significant risk of cutting something unintentionally, or in a worst-case scenario, getting severely injured.

### SUMMARY

An object of the present invention is to provide an arrangement to reduce the risk of unintentional use of the sharp edge while allowing the hammer head to be used.

The invention is based on the idea of providing a blade cover for the sharp edge with a locking mechanism and a hatchet assembly. The locking mechanism prevents the blade cover to fall off during the usage of the hammer head and simultaneously prevents the sharp edge to be utilized accidently.

### BRIEF DESCRIPTION OF THE DRAWINGS

In the following the invention will be described in greater detail by means of preferred embodiments with reference to the attached drawings, in which

FIG. 1 shows an axe assembly according to an embodiment;

FIG. 2 shows an example of an axe with a through hole;

FIG. 3 shows a blade cover with a rotatable switch attached;

FIG. 4 shows a back view of the blade cover; and

FIG. 5 shows a blade cover, where the rotatable switch is separated from a receiver.

### DETAILED DESCRIPTION

The present invention pertains to an axe assembly. The axe assembly comprises an axe 1 and a blade cover 2. The axe 1 may be any kind of axe with a handle 10 and a tool head 11 but in the present Figures, the axe 1 is illustrated as a hatchet.

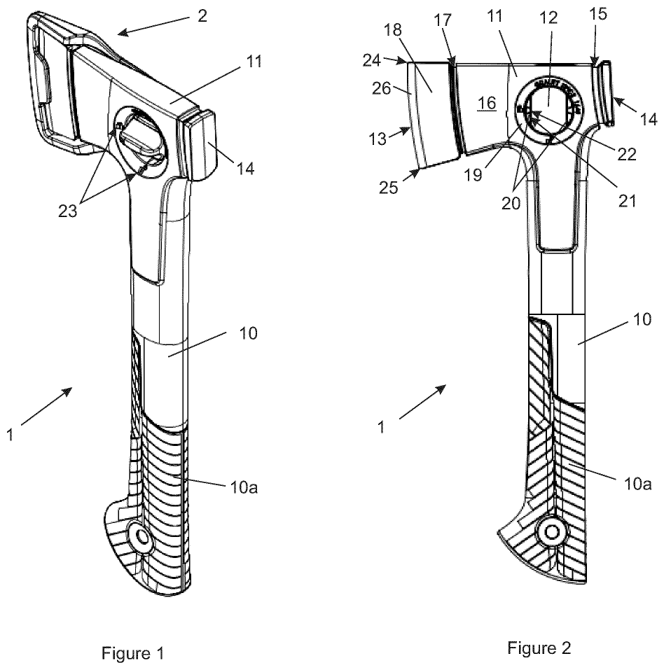

FIG. 1 shows the axe assembly according to an embodiment and FIG. 2 shows an example of the axe 1 with a through hole 12. The axe 1 comprises a handle 10 and a tool head 11. The tool head 11 comprises a sharp edge 13 on one side and a hammer head 14 on the other side. Between the sharp edge 13 and the hammer head 14 comprises a through hole 12, where an axis of the through hole 12 is preferably perpendicular to a longitudinal axis of the handle 10.

The tool head 11 is made of a first material, preferably steel, and at least part of the handle 10 is made of a second material, preferably polymer or composite material by injection molding, wherein the second material at least partially surrounds the tool head 11 and the through hole 12.

The tool head 11 is preferably made with forging but other manufacturing methods may be implemented, such as casting and hot rolling. An initial through hole may be circular or an open circle with a slot for facilitating the connection between the tool head 11 and the second material.

The handle 10 may be hollow, semi-hollow or solid. The whole handle 10 may be made of the second material, or a grip portion 10a of the handle 10 may be made of a third material while the second material connects the tool head 11 and the grip portion 10a together. The third material can be made of softer material such as thermoplastic elastomer or wood, for example.

The tool head 11 may comprise a first groove 15 around the tool head 11 separating the hammer head 14 portion from a cheek 16 of the tool head 11. The tool head 11 may comprise a second groove 17 around the tool head 11 separating a blade portion 18 from the cheek 16. Said grooves 15, 17 may facilitate injection molding of the second material and determine the final appearance. The area between said grooves 15, 17 may define the injection molding area and the areas outside the grooves 15, 17 remain exposed with the first material. The second material may form a bevel 19 around the through hole 12 for softening the edge of the through hole 12 and to facilitate attaching the blade cover 2.

The through hole 12 is preferably within the width of the handle 10 for a better ergonomic use. However, in some embodiments, the through hole 12 may locate partially or completely outside the width of the handle 10.

The through hole 12 may have different shapes. The initial through hole in the tool head 11 can be circular or the open circle and is preferably co-manufactured with the tool head 11 by forging. However, the initial hole may also be post-manufactured by drilling or machining. During the injection molding of the second material, the second material may form a minor segment inside the initial through hole altering the shape of the final through hole 12. As shown in FIG. 2, the second material has formed two circular segments as rims 20 on each side of the through hole 12 so the final through hole 12 is oval shaped. In another embodiment, the final shape of the through hole 12 may be for example square, rectangle, triangle, circle, semicircle, pentagon, hexagon, etc.

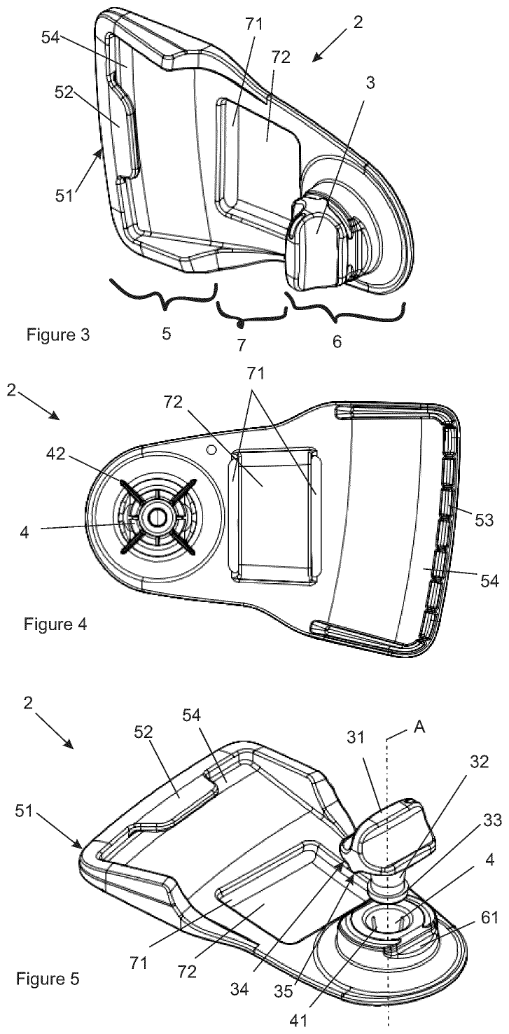

FIGS. 3-5 shows a blade cover 2 according to an embodiment. FIG. 3 illustrates a blade cover 2 with a rotatable switch 3 attached, FIG. 4 illustrates a back view of the blade cover 2, and FIG. 5 illustrates a blade cover 2, where the rotatable switch 3 is separated from a receiver 4.

The blade cover 2 comprises a protective portion 5 arranged to cover the sharp edge 13 of the tool head 11 and a locking mechanism 6 releasably attachable to the tool head 11. The protective portion 5 is preferably on one end of the blade cover 2 and the locking mechanism 6 is on the other end of the blade cover 2, opposite the protective portion 5. In the accompanying Figures, the blade cover 2 is illustrated as paddle shaped with optimal rigidity and material application but it may have a different shape in other implementations.

The locking mechanism 6 may comprise a rotatable switch 3 and a receiver 4 fitted to receive the rotatable switch 3. The locking mechanism 6 is arranged to align with the through hole 12 so the through hole 12 and the rotatable switch 3 may have coinciding axis A when the blade cover 2 is attached to the tool head 11.

The rotatable switch 3 is arranged to be rotatable in relation to the receiver 4 when fastened to the receiver 4 and comprises a holder portion 31 to which the user can hold between fingers. The holder portion 31 can be a protrusion, or it can be flat or rounded knob. In the accompanying Figures, the holder portion 31 is illustrated as a flange extending outward from an exterior surface of the rotatable switch 3. The rotatable switch 3 may additionally comprise a shaft 32 with a snap lock pin 33.

The rotatable switch 3 is fastened to the receiver 4 preferably by snap fastening, but other mechanical fastening means may be implemented for allowing the rotatable switch 3 to rotate about the axis A, such as a threaded element. According to the embodiment illustrated in FIG. 5, the receiver 4 comprises a frustum surface 41 made of at least two parts for tolerating elastic deformation and the rotatable switch 3 comprising the snap lock pin 33, wherein the rotatable switch 3 is snap fastened to the receiver 4 by guiding the snap lock pin 33 between said at least two parts of the frustum surface 41 and overcoming the elastic deformation threshold. The frustum surface 41 in this context refers to a truncated cone or pyramid shape having a discontinuous inner surface.

The snap lock pin 33 is illustrated as an elongated stem with an end having larger cross-section than the remaining stem preventing the snap lock pin 33 to disengage from the receiver 4 but allowing the rotatable switch 3 to rotate in relation to the receiver 4. The receiver 4 may alternatively comprise a tubular surface and the snap lock pin 33 may comprise at least one outward hook for engaging with an outer end of the tube.

In another embodiment features of the rotatable switch 3 and the receiver 4 may be reversed as the receiver 4 may comprise the snap lock pin 33 and the rotatable switch 3 may comprise the frustum or tubular surface.

The locking mechanism 6 may comprise a recess 61 fitted to accommodate the rim 20 of the through hole 12 when the blade cover 2 is attached to the tool head 11. This contact may facilitate positioning the locking mechanism 6 to the optimal spot in relation to the through hole 12.

The receiver 4 may comprise at least one additional support element 42 for supporting the receiver 4 to the locking mechanism 6. The additional support element 42 may be a plate connecting the outer surface of the receiver 4 to the back side of the locking mechanism 6. FIG. 4 shows four additional support elements 42 evenly supporting the receiver 4 but other embodiments may comprise more or less additional support elements 42.

The rotatable switch 3 is rotatable between two positions, wherein in a first position the blade cover 2 is fixedly securable to the tool head 11, and in a second position the blade cover 2 is releasably attachable to the tool head 11. The first position is switched to the second position by rotating the rotatable switch 3 around the axis A. The rotatable switch 3 is arranged to pass through the through hole 12 in the second position.

In the accompanying Figures, the rotatable switch 3 is arranged to rotate approximately 90 degrees to change between the first position and the second position. However, depending on the shape of the through hole 12, the rotation rate may vary. For instance, it can be 45 degrees for a triangle shaped through hole, or 180 degrees for a semicircle shaped through hole.

The rotatable switch 3 comprises a first mating surface 34, and the tool head 11 comprises a second mating surface 21, where the second mating surface 21 may locate at an edge of the through hole 12. The first mating surface 34 is arranged to abut on the second mating surface 21 in the first position. The first mating surface 34 may be a surface of the outward section extending from the shaft 32 or a surface of the hook of the snap lock pin 33 of the rotatable switch 3 or threaded element formed on the surface of shaft 32 allowing the first mating surface 34 to contact the second mating surface 21 at the edge of the through hole 12. The second mating surface 21 may locate at the rim 20 inside the through hole 12. In another embodiment, the second mating surface 21 may locate at an outside rim of the through hole 12.

The first mating surface 34 may locate at a distance away from the holder portion 31 so the second mating surface 21 may fit between the holder portion 31 and the first mating surface 34. In the present Figures, the rim 20 of the through hole 12 is arranged to abut the rotatable switch 3 in the second position. The second mating surface 21 may respectively be flat or have a threaded formation.

In the embodiment illustrated in FIG. 2, the second mating surface 21 may comprise a depression 22 allowing a matching projection 35 of the rotatable switch 3 to slide to the ideal first position.

When the first mating surface 34 and the second mating surface 21 are in contact with each other, the first mating surface 34 is abutting the second mating surface 21, the rotatable switch 3 is arranged to be securely fastened to the tool head 11 preventing the blade cover 2 to detach from the tool head 11. When the rotatable switch 3 is changed to the second position, and the first mating surface 34 and the second mating surface 21 are no longer in contact with each other, the blade cover 2 can be detached from the tool head 11 by passing the rotatable switch 3 through the through hole 12.

The second mating surface 21 may be formed of the second material arranged inside the initial through hole by injection molding. The second material is more moldable to the desired shape and design but is hard and tough enough to withstand impact and stress applied to the tool head 11. The second material is also lighter compared to steel making the final weight of the axe 1 lighter.

Lock and unlock signs 23 may be applied on the second material, for instance on the bevel 19, to indicate which one is the first position, and which one is the second position of the rotatable switch 3.

The blade cover 2 may be manufactured of same material as the second material, or it can be manufactured of different thermoplastic polymer such as polypropylene (PP) or polyethylene (PE). Both polymers have good chemical and mechanical properties.

The protective portion 5 may comprise an edge protecting strip 51 and at least one front sideward extension 52 and at least one back sideward extension 54 extending from respective front side and back side of the edge protecting strip 51. The protective portion 5 is arranged to receive the blade portion 18 and the edge protecting strip 51 may conform with the shape of the sharp edge 13 surrounding toe 24 and heel 25 portions of the tool head 11. At least one of the sideward extensions 52, 54 may conform with outer surface of a bevel face 26 of the tool head 11 for a snug fitting. However, in some embodiments the fitting may be slightly loose. The edge protecting strip 51 may be reinforced by additional thickness or reinforcement elements 53 to prevent the sharp edge 13 from cracking the blade cover 2. The additional reinforcement elements 53 may be partially hollow cavities along the edge protecting strip 51.

In the embodiment illustrated in the present FIGS. 3-5, the back sideward extension 54 may cover one side of the bevel face 26 completely and the protective portion 5 is designed as a half open case. However, in another embodiment, the back sideward extension 54 may cover the bevel face 26 only partially. The front sideward extension 52 may at least partially cover the other bevel face 26 for easier attaching and detaching of the tool head 11. The front side in this context refers to the same side as the rotatable switch 3, and the back side refers to the same side as the receiver 4.

A central vertical plane of the edge protecting strip 51 can be on a same vertical plane as one of the mating surfaces 34, 21, when the tool head 11 is in upward position and the handle 10 is in downward position.

The back sideward extension 54 may be connected to the locking mechanism 6 via a connecting portion 7. The connecting portion 7 may comprise a clip or at least two slits 71 for attaching the blade cover 2 to a belt or a strap allowing the axe assembly to be suspended by a strap from a backpack or a belt while trekking. The connecting portion 7 may comprise a protruded portion 72 between the two slits 71. The protruded portion 72 allows the strap or belt to be inserted and removed more easily through the slits 71 without bending the strap or belt.

The protecting portion 5, the connecting portion 7 and the locking mechanism 6 excluding the rotatable switch 3 may be integrally manufactured as one component, preferably by injection molding. The rotatable switch 3 may be manufactured as a second component to be attached to the receiver 4 afterwards.

The blade cover 2 can be attached to the axe 1 at the middle of the tool head 11 leaving the hammer head 14 of the axe 1 uncovered. With the blade cover of the present invention, the blade cover 2 is firmly attached to the axe 1 so that it would not disengage from the tool head 11 while using the hammer head 14.

What is claimed is:

1. A blade cover for an axe, comprising
a protective portion arranged to cover a sharp edge of a tool head,
a locking mechanism releasably attachable to the tool head, the locking-mechanism comprising a rotatable switch and a receiver, the rotatable switch is rotatable between two positions, wherein in a first position the blade cover is fixedly securable to the tool head, and in a second position the blade cover is releasably attachable to the tool head.

2. The blade cover as claimed in claim 1, wherein the protective portion is on one end of the blade cover and the locking mechanism is on the other end of the blade cover, opposite the protective portion.

3. The blade cover as claimed in claim 1, wherein the protective portion comprises an edge protecting strip and at least one front sideward extension and at least one back sideward extension from respective front side and back side of the edge protecting strip.

4. The blade cover as claimed in claim 3, wherein the back sideward extension is connected to the locking mechanism via a connecting portion.

5. The blade cover as claimed in claim 4, wherein the connecting portion comprises a clip or at least two slits for attaching the blade cover to a belt or a strap.

6. The blade cover as claimed in claim 5, wherein the connecting portion comprises a protruded portion between the two slits.

7. The blade cover as claimed in claim 1, wherein the protecting portion, the connecting portion and the locking mechanism excluding the rotatable switch are integrally manufactured as one component.

8. The blade cover as claimed in claim 1, wherein the rotatable switch is fastened to the receiver by snap fastening.

9. The blade cover as claimed in claim 8, wherein the receiver comprises a frustum surface made of at least two parts and the rotatable switch comprises a snap lock pin, wherein the rotatable switch is snap fastened to the receiver by guiding the snap lock pin between said at least two parts of the frustum surface.

10. An axe assembly, comprising
an axe having a tool head and a handle, wherein the tool head comprises a through hole, and
a blade cover as claimed in claim 1.

11. The axe assembly as claimed in claim 10, wherein the through hole and the rotatable switch has a coinciding axis when the blade cover is attached to the tool head.

12. The axe assembly as claimed in claim 11, wherein the rotatable switch comprises a first mating surface, and the tool head comprises a second mating surface at an edge of the through hole, wherein the first mating surface is arranged to abut on the second mating surface in the first position.

13. The axe assembly as claimed in claim 12, wherein the second mating surface comprises a depression.

14. The axe assembly as claimed in claim 10, wherein the tool head is made of a first material and the handle is made of a second material, wherein the second material at least partially surrounds the tool head and the through hole.

15. The axe assembly as claimed in claim 14, wherein the second mating surface is made of the second material.
